(19) United States
(12) Patent Application Publication
(10) Pub. No.: US 2007/0046969 A1
(43) Pub. Date: Mar. 1, 2007

(54) Image data control apparatus, image data control method, and recording medium for storing program

(75) Inventors: Toshimi Shinchi, Tokyo (JP); Tamotsu Sakuraba, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/293,473

(22) Filed: Dec. 1, 2005

(30) Foreign Application Priority Data
Aug. 26, 2005 (JP) 2005-245815

(51) Int. Cl. G06F 3/12

(52) U.S. Cl. 358/1.13

(57) ABSTRACT

An image data control apparatus includes: a job analysis section for detecting property data which is included in a file for storing supplied document image data and which shows a property of the document image data; and an interpreter section for generating data for photographic printing based on the property data detected by the job analysis section and the document image data.

### BACKGROUND OF THE INVENTION

1. Field of the Invention

The present invention relates to an image data control apparatus, an image data control method, and a recording medium for storing a program for property data.

2. Description of Related Art

Conventionally, various image forming apparatuses have been known that are supplied with data (e.g., data of text, image) prepared by specific application software in a host device (hereinafter simply referred to as “host”) (e.g., PC (Personal Computer)) to form an image. The host is connected with the image forming apparatus via a cable or the like to perform the transmission and reception of image data or the like. Recently, having been constructed is a system in which a plurality of remote hosts communicate each other to send and receive data through LAN (Local Area Network), WAN (Wide Area Network), MAN (Metropolitan Area Network), and broadband environment such as Internet, thereby form an image on a recording medium. This field has been and is being researched and developed intensely. For example, it has been common that a company office constructs an in-house LAN through which the employees share one or a plurality of image forming apparatus(es). Furthermore, in printing business and publishing business in recent years, a business model represented by POD (Print On Demand) has been becoming popular in recent years to reduce the cost for manufacturing a plate to realize printing task with a small lot with a low cost. The image formation system as described above has been indispensable for the recent business environment utilizing IT (Information Technology).

While an image forming apparatus prints images based on image data sent from a plurality of hosts, the apparatus discharges the printed papers to a discharge tray in a superimposed manner without distinguish the papers from each other regardless of the printed papers' being based on the plurality of sets of data sent from the different hosts image forming apparatus Due to this reason, an outputted bundle of printed papers document includes printed papers of documents from a plurality of hosts. Such outputted printed papers of documents are frequently sorted manually. This is a problem because a significant burden is caused for a business operation, especially when the number of hosts and an amount to be printed are enormous as in the case of the business using POD.

With regards to this point, an image forming apparatus has been disclosed in Japanese Laid-Open Publication No. 8-314654 as a technique for reducing the burden to sort outputted printed papers of documents. According to this technique, the image forming apparatus automatically outputs a so-called banner page at the top of the printed papers of a document for each host that functions as a front cover on which a preparer name, a title, and date or the like of the document are printed. Specifically, before the host sends the document data to the image forming apparatus, a data file for the banner page is prepared separately from a file for the document data. Thereafter, the data for the banner page is sent simultaneously with the transmission of the document data. The image forming apparatus includes a recognition means for recognizing the data file for the banner page. The image forming apparatus is designed, when the recognition means recognizes the data file for the banner page, to printout the banner page prior to the printing of the document data. This can provide the bundle of printed papers of documents outputted to a discharge tray of the image forming apparatus such that a banner page is provided at the top of printed papers of each document, thereby reducing the burden to sort the printed papers of documents.

However, the image forming apparatus disclosed in Japanese Laid-Open Publication No. 8-314654 causes a burden to prepare the data for the banner page and a burden to prepare the file for storing the data for this banner page separately from the data for the document or the like. The image forming apparatus disclosed in Japanese Laid-Open Publication No. 8-314654 also causes a burden for the host and the image forming apparatus to manage the files. Furthermore, the format of the prepared banner page is generally arbitrarily prepared by an operator of the host and thus is not necessarily prepared by a unified format. Thus, pieces of information for the outputted banner pages have no regularity, causing a burden for the image forming apparatus to understand, when outputting the document, the details of the information. This causes a problem of causing an inefficient task for sorting the documents for the respective hosts. This problem is particularly serious in a business using POD.

### SUMMARY

The present invention is made to solve the problem as described above. Thus, it is an object of the present invention to provide an image data control apparatus, an image data control method, and a program through which the printing of data for a banner page is controlled without separately managing a file of data for the banner page and a file of data for a document or the like.

The above objective of the present invention is achieved by the configurations as shown below.

In accordance with an embodiment according to the first aspect of the present invention, image data control apparatus comprises:

a job analysis section for detecting property data which is included in a file for storing document image data and which shows a property of the document image data; and

an interpreter section for generating data for printing based on the property data detected by the job analysis section and the document image data.

Preferably, the property data detected by the job analysis section is sent to the interpreter section prior to the document image data.

Preferably, the job analysis section further detects whether an identifier for requesting a predetermined code exists or not when the property data is read from the file of the document image data, and reads the property data based on a decoding code for decoding the code when the identifier is detected.

In accordance with an embodiment according to the second aspect of the present invention, an image data control method comprises:

detecting property data which is included in a file of document image data supplied and which shows a property of the document image data; and

generating data for printing based on the property data detected in the detecting of the property data and the document image data.

Preferably, the image data control method further comprises sending the property data detected in the generating of the data for printing to the interpreter section prior to the document image data.

Preferably, the image data control method further comprises: detecting whether an identifier for requesting a predetermined code exists or not when the property data is read from the file of the document image data in the detecting of the property data, and reading the property data based on a decoding code for decoding the code when the identifier is detected.

In accordance with an embodiment according to the third aspect of the present invention, a recording medium for storing a program, wherein the program causes a computer for processing document image data supplied to realize:

a job analysis function for detecting property data showing a property of the supplied document image data from a file of the document image data; and

an interpreter function for generating data for printing based on the property data detected by the job analysis function and the document image data.

Preferably, the program causes the computer to further realize a function for sending data for printing of the property data to an interpreter section prior to data for printing of the document image data in the job analysis function.

Preferably, the program causes the computer to further realize a function for detecting whether an identifier for requesting a predetermined code exists or not when the property data is read from the file of the document image data in the job analysis function, and a function for reading the property data based on a decoding code for decoding the code when the identifier is detected.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a diagram illustrating the outline of the entire structure of an image formation system in an embodiment of the present invention;

FIG. 2 is a diagram illustrating the outline of the structure of a host PC in an embodiment of the present invention;

FIG. 3 is a diagram illustrating the outline of the structure of an image forming apparatus in an embodiment of the present invention;

FIG. 4 is a diagram illustrating the outline of a functional structure of the control section of the image forming apparatus shown in FIG. 3;

FIG. 5 is a schematic diagram illustrating how property data is recorded in an embodiment of the present invention;

FIG. 6 is a schematic diagram illustrating a window in a host in which property data is edited in an embodiment of the present invention;

FIG. 7 is a schematic diagram illustrating an example of a data set detected by a processing for extracting property data in an embodiment of the present invention;

FIG. 8 is a flow diagram illustrating an example of a processing by the control section of the image forming apparatus shown in FIG. 4;

FIG. 9 is a flow diagram illustrating an operation of the image forming apparatus shown in FIG. 3; and

FIG. 10 is a schematic diagram illustrating a banner page and a document page photographically printed by the image formation system in an embodiment of the present invention.

### DETAILED DESCRIPTION OF PREFERRED EMBODIMENTS

Hereinafter, an embodiment of the present invention is described in detail with reference to the drawings.

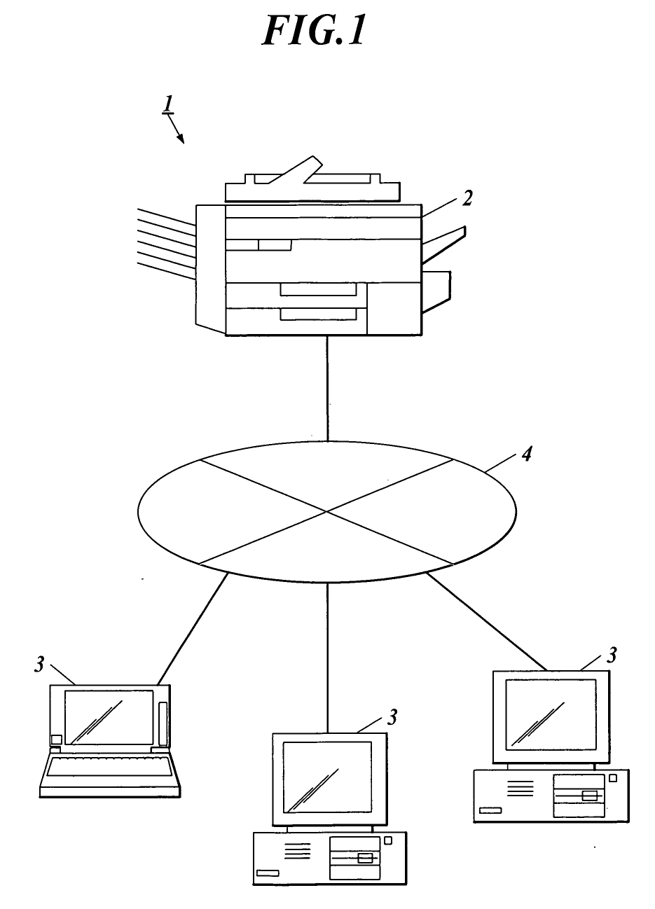

FIG. 1 shows the outline of the entire structure of the image formation system 1 to which the image data control apparatus according to the present invention is employed.

The image formation system 1 comprises the image forming apparatus 2 and the host 3 that are connected by the network 4 to have transmission and reception of electronic data. The network 4 is a communication network established by LAN, WAN, MAN, or the Internet for example. Data representing document image (hereinafter simply referred as “document image data”) sent from the host 3 is transmitted to the image forming apparatus 2 via the network 4. In this embodiment, the document image data is transferred in a form of data file, such as PDF (Portable Document Format) format, as explained below.

The host 3 may be a work station, a personal computer, or a laptop personal computer for example. The host 3 can use various types of application software such as document preparation, spreadsheet, and graphic drawing software for example. The data of a document image prepared by these application software is sent via the network 4 to the image forming apparatus 2. It is noted that the description below assumes that the document data to be prepared and sent is based on a PDF format. Together with the document image data, property data showing the property of the document data is sent via the network 4 to the image forming apparatus 2. The property data is described later.

The image forming apparatus 2 may be a copier, a laser printer, or an ink jet printer for example. Based on the document image data supplied via the network 4, an image is formed on a recording medium. In an example of this embodiment, a tandem type color laser printer is used.

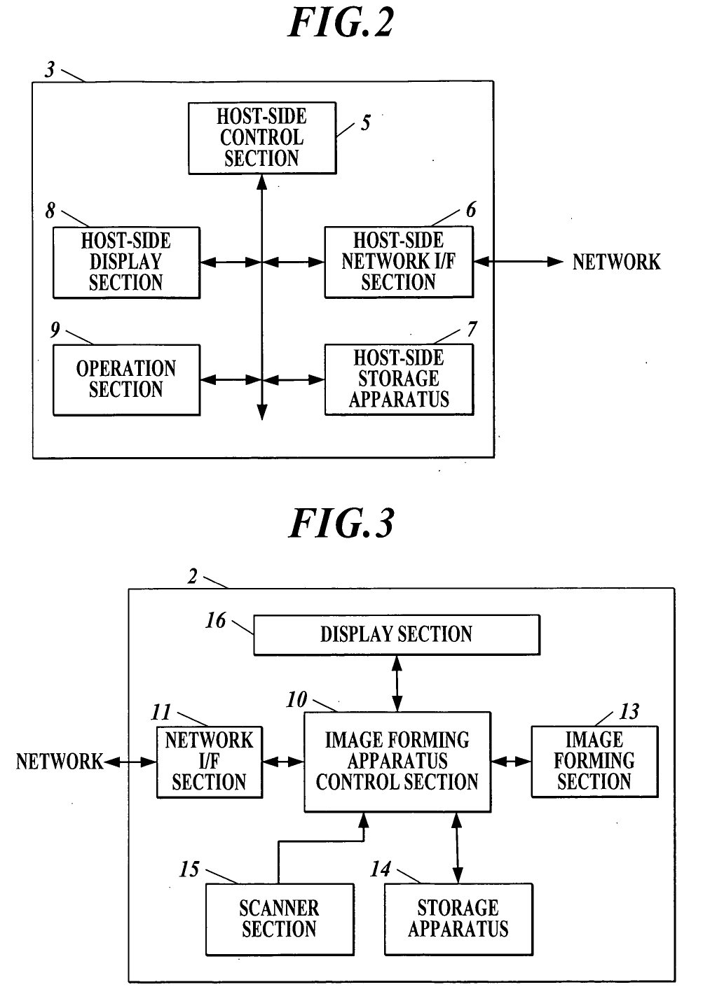

FIG. 2 shows the structure of the host 3. The host 3 includes: the host-side control section 5, the host-side network I/F (Inter/Face) section 6, the host-side storage apparatus 7, the host-side display section 8, and the operation section 9. The host-side control section 5 controls the entirety of the host 3 in accordance with an operation program and/or an application program previously stored in the host-side storage apparatus 7. For example, when document preparation software is used as application software, based on an input signal sent when an operator operates the operation section 9, the host-side display section 8 displays document sentences or the like and the prepared document image data is temporarily stored or stored in the host-side storage apparatus 7. Thereafter, the temporarily-stored or stored document image data is supplied from the host-side network I/F section 6 via the network 4 to the image forming apparatus 2.

Here, the property data of the document image data prepared by the host 3 is described. The property data is data showing various pieces of information regarding the contents of the document. Specifically, the property data shows the description of the document data such as the name of a preparer of the document data, the address of this preparer, the name of a manufacturer, the product name of the document, and the number of pages of the document, for example. The property data is characterized in being included in the data of a file of the document image. Generally, when performing a printing of the data showing the contents of the document as well as data showing another information in the image forming apparatus or the like, it is required to prepare data showing the another information as a part of the data showing the contents of the document. For example, it is required to prepare the data so that the first page showing the contents of the document corresponds to the data of a front cover page or the like describing the document preparer or the like and pages after the first page correspond to the data describing the contents of the document. Alternatively, in addition to a file of the data showing the contents of the document, another file must be provided to include data describing the name of the document preparer or the like. In contrast to this, the property data can be stored in a single file including the data of the document image, simplifying the data management.

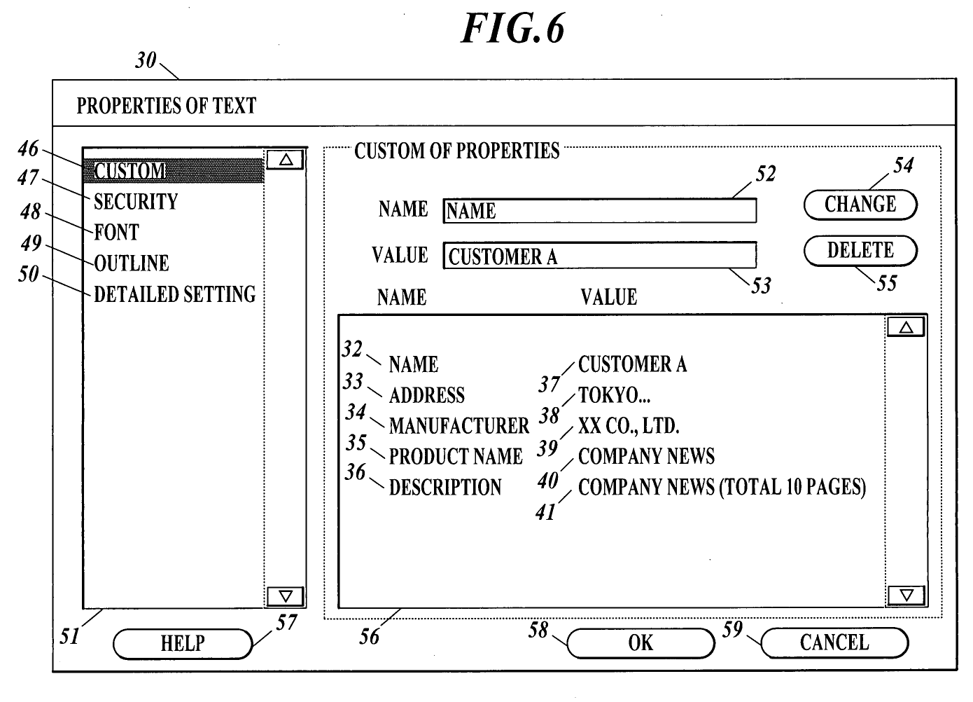

Furthermore, the property data can also be automatically prepared in accordance with the contents previously set by the function of the application software. Alternatively, the property data (e.g., name of the document preparer) can also be arbitrarily prepared by the operator of the host 3. FIG. 6 shows an example of the preparation of the property data. FIG. 6 shows an example of the property data window 30 displayed on the host-side display section 8 by an operation by the operator. The property data window 30 is displayed when a function button that is one of the functions owned by the application software and that is displayed in a window (not shown) in which a text or the like is prepared is clicked by a mouse or the like. Simultaneously with the display of the property data window 30, the contents of the currently-set property data are displayed.

The edit item selection field 51 includes the five edit items of: “custom” 46 by which a property data item can be arbitrarily prepared; “security” 47 by which various safety managements are set with regards to the document image data; “font” 48 by which a letter type used in the preparation of the document is set; “outline” 49 showing the outline of various settings for the current property data; and “detailed setting” 59 showing various settings for the property data in detail. In the example of FIG. 6, the operator operates the edit item selection field 51 to select “custom” 46, showing the screen in which the property data is edited. An individual item to be edited is prepared by inputting the name of an arbitrary individual item via a keyboard or the like to the individual item name input field 52. Corresponding information corresponding to this individual item is prepared by inputting arbitrary contents via a keyboard or the like to the corresponding information value input field 53. For example, in the case of FIG. 6, “name” is inputted to the individual item name input field 52 and “customer A” as corresponding information corresponding to this “name” is inputted to the corresponding information value input field 53. When the input is completed, the “change” button 54 is clicked. In order to delete an individual item and the corresponding information, the “delete” button 55 is clicked.

When the “change” button 54 is clicked, the edit content display field 56 displays an individual item and the corresponding information. FIG. 6 shows the inputted individual items of: the “name” 32, “address” 33, “manufacturer” 34, “product name” 35, and “description” 36 as well as corresponding information of the “customer A” 37, “Tokyo. . .” 38, “XX Co., Ltd.” 39, “company news” 40, and “company news (total 10 pages)” 41, respectively.

When the respective inputs of the property data are completed, the “OK” button 58 is clicked to finish the editing of the property data. As a result, the property data showing the property of the document image data currently being prepared is set and is stored in the same file as that of the document image data. When canceling the editing of the property data, the “cancel” button 59 is clicked to close the property data window 30 from the host-side display section 8, thereby stopping the editing of the property data. It is noted that the “help” button 57 is a button by which an operation description window is displayed for showing various explanations of the editing of the property data and the function.

Furthermore, the document preparation application software in the host 3 for preparing the document image data has a function that can be set to require the input of a password in order to develop the property data based on the file. By inputting an arbitrary code through a password-setting screen (not shown), the input of a password can be requested in order to open the property data so that, when a right password is not inputted, the image forming apparatus 2 can be prevented from printing the property data. Specifically, when the host 3 is set to request the input of a password, the property data is provided to include an identifier so that, when this identifier is detected during the processing by the image forming apparatus 2, the printing of the property data is not performed and only the document image data is printed.

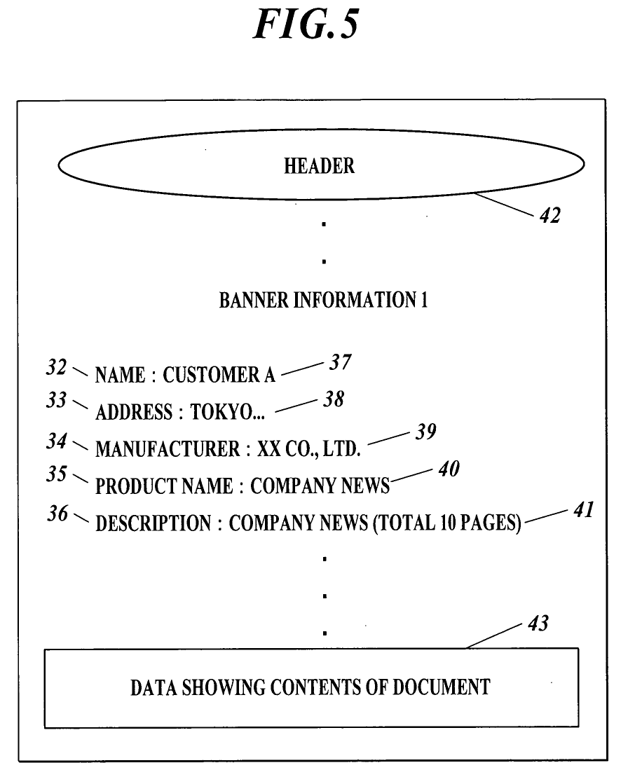

FIG. 5 schematically shows the structure of the data in a file for storing the document image data when the file is sent from the host 3 to the image forming apparatus 2. In FIG. 5, the header 42 shows the address of the sender of the data for example and the document data 43 is data showing the contents of the document prepared by the operator. In this way, the file to be sent includes both of the data showing the contents of the document (i.e., document image) and the data showing the property of the document.

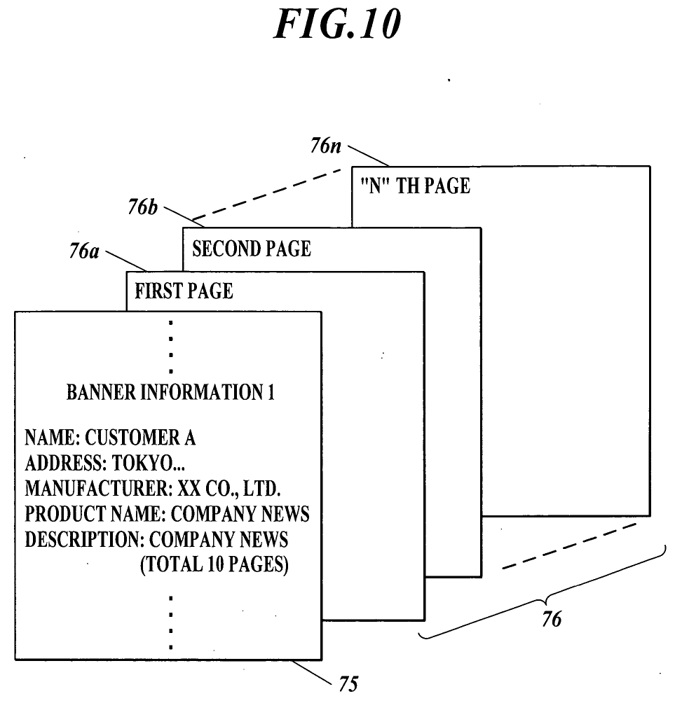

When the document image data sent to the image forming apparatus 2 is printed by the image forming apparatus 2, the banner page 75 showing the property of the document and the document pages 76a, 76b, and 76n are printed (see FIG. 10).

Returning to FIG. 2, the host-side storage apparatus 7 is composed by a non-volatile memory (e.g., hard disk, EPROM (Erasable Programmable Read Only Memory), EEPROM (Electrical Erasable Programmable Read Only Memory)). The host-side storage apparatus 7 temporarily stores or stores an operation program and an application software used by the host 3, the data inputted from the operation section 9, and various pieces of data subjected to various computations by the host-side control section 5 for example.

The host-side network I/F section 6 is composed by an external communication apparatus (e.g., NIC (Network Interface Card)). The host-side network I/F section 6 provides communication by converting the format of data to be sent (or to be received) in accordance with the protocol of the network 4. The communication is performed by an instruction signal outputted from the host-side control section 5 in accordance with a previously-installed communication program.

The host-side display section 8 is a display apparatus such as FPD (Flat Display Panel), e.g., a TFT (Thin film Transistor) liquid crystal element, an organic EL (Electronic Luminescence) element, and the like, or CRT (Cathode Ray Tube). The operation section 9 includes an input apparatus (e.g., keyboard, mouse) and outputs an input signal to the host-side control section 5 in accordance with the operation by an operator.

Next, the image forming apparatus 2 is described. FIG. 3 shows the outline of the structure of the image forming apparatus 2. The image forming apparatus 2 is composed by: the image forming apparatus control section 10, the network I/F section 11, the image forming section 13, the storage apparatus 14, the display section 16, and the scanner section 15.

In accordance with the control program stored in the storage apparatus 14, the image forming apparatus control section 10 controls the entirety of the image forming apparatus 2. The image forming apparatus control section 10 obtains document data or the like from the network I/F section 11 or the scanner section 15 (which is described later) to perform various data processings for the formation of the image, thereby generating data for printing that can be processed by the image forming section 13. The image forming apparatus control section 10 also sends to the storage apparatus 14, depending on the amount of the data of the document image received by the network I/F section 11 or the like or the various processings by the image forming apparatus control section 10, an instruction to temporarily store, to store, or to read-out the document image data.

As in the case of the host-side network I/F section 6 as described above, the network I/F section 11 is composed by an external communication apparatus (e.g., NIC). In accordance with the protocol for the network 4, data inputted to and outputted from the image forming apparatus 2 is sent or received by the network I/F section 11. When being supplied with document image data from the network 4, the network I/F section 11 converts the data of the communication format according to the protocol for the network 4 to data that can be processed by the image forming apparatus 2, thereby sending the converted data to the image forming apparatus control section 10.

The storage apparatus 14 consists of a non-volatile memory (e.g., hard disk, EPROM, EEPROM). The storage apparatus 14 temporarily stores or stores document image data or the like sent from the I/F section 11 or the image forming apparatus control section 10. More specifically, the storage apparatus 14 temporarily stores document data in accordance with a time required for the image forming apparatus control section 10 to process the document data by various ways or temporarily stores data for printing in accordance with a time required for the image formation section 13 to print the data, for example.

The image formation section 13 forms an image on a recording medium based on data for printing, which is supplied from the image forming apparatus control section 10. In this embodiment, the image forming section 13 has a tandem type printing mechanism. In the tandem type printing mechanism, an exposure apparatus raster-scans laser on a photoconductor drum to support an electrostatic latent image so that toner is adhered to this photoconductor drum, thereby transferring the formed toner image to an intermediate transfer belt. This toner image transferred to the intermediate transfer belt is transferred to a recording medium by being pressed by a transfer roller. The image formation section 13 includes image forming units corresponding to the respective toners of yellow, magenta, cyan, and black in order to form a color image.

The display section 16 comprises FDP using a TFT liquid crystal display element or an organic EL element. The display section 16 may also be a display apparatus using CRT for example. The display section 16 can include a touch panel through which various setting values, e.g., the number of the documents and a kind of the recording media, can be inputted. The display section 16 displays various settings such as various processings and results performed by the image forming apparatus 2, the number of documents for printing, image density, and a selected size of a recording medium. Furthermore, the display section 16 sequentially displays an order of the printing of pieces of document image data sent from the respective hosts 3 (hereinafter simply referred to as “job”).

The scanner section 15 emits light to a document so that the reflected light is caught by an optical reading apparatus using CCD (Charge Coupled Device) image sensor to convert the light to an electronic signal by photoelectric conversion phenomenon, thereby sending the signal to the image forming apparatus control section 10. The image forming apparatus 2 can also copy an image based on document image data sent from the scanner section 15.

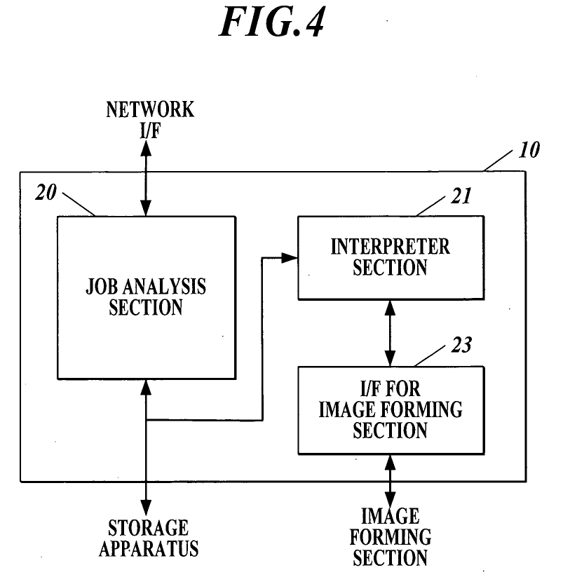

Next, the image forming apparatus control section 10 is described in more detail. FIG. 4 is a schematic diagram illustrating the functional structure of the image forming apparatus control section 10. The image forming apparatus control section 10 provides a control in which CPU (Central Processing Section) (not shown) develops a control program previously stored in the storage apparatus 14 (see FIG. 3) into RAM (Random Access Memory) (not shown), thereby subjecting the document image data to various data processings. By executing the control program, the image forming apparatus control section 10 provides a function section of the job analysis section 20, the interpreter section 21, and the I/F 23 for image forming section.

The job analysis section 20 subjects a file storing the document image data supplied from the network I/F section 11 to a symbolic analysis. Specifically, the job analysis section 20 detects the format of the data of the supplied file (which is PDF in the example of this embodiment), detects the header 42 (see FIG. 5) (e.g., MAC (Media Access Control) address) of the host 3 to which the address document data is sent, and detects the existence or nonexistence of property data that is data for printing a banner page. When detecting the existence of the property data, the job analysis section 20 performs the symbolic analysis of the respective individual items of the property data for example (see FIG. 6) and performs the symbolic analysis of the data showing the contents of the document. When not detecting the existence of the property data in the file, the job analysis section 20 performs the symbolic analysis of the data showing the contents of the document only. After the symbolic analysis, the job analysis section 20 firstly sends the property data to the interpreter section 21 prior to the data showing the contents of the document.

It is noted that, although the job analysis section 20 performs the symbolic analysis of the file with the top of the file, the property data is not always at the top of the file and may be in the middle of or at the end of the file. Thus, the job analysis section 20 is designed, although the details is described later, to determine property data by using a specific symbol owned by the property data as a landmark and to discriminate the start point and end pint of specific data. The example of this embodiment is described on an assumption that the “/ModDate” 61 is a specific symbol showing the start point of specific data and the “endobj” 72 is a specific symbol showing the end point. When the “/ModDate” 61 is not detected from the data subjected to the symbolic analysis from the top, the job analysis section 20 discriminates that the data now being subjected to the symbolic analysis is the document image data and performs symbolic analysis for subsequent parts to send the data to the storage apparatus 14 at an appropriate timing so that the storage apparatus 14 temporarily stores the data. Thereafter, when detecting the “/ModDate” 61, the job analysis section 20 discriminates property data. Then, the job analysis section 20 sequentially performs the symbolic analysis until the “endobj” 72 showing the end of the property data is detected to discriminate specific data to send the specific data to the storage apparatus 14 at an appropriate timing. When detecting the “endobj” 72, the job analysis section 20 discriminates the end of the specific data. Thereafter, the job analysis section 20 sequentially subjects the file data to the symbolic analysis and, after detecting the EOF (End Of file) showing the end of the file data, sends the property data temporarily stored in the storage apparatus 14 to the interpreter section 21 prior to the document image data. Thereafter, the property data is processed prior to the document image data until the printing by the image forming section 13 is performed.

When an identifier in the file requesting the input of a password for the development of the property data (specifically, for execution of a symbolic analysis) is detected, the display section 16 is caused to show a display showing that the input of a password is requested and the operator of the image forming apparatus 2 is requested to input a password. For example, when an identifier of “/Filter/Standard/” is detected in the file data, the display section 16 is caused to show a display showing that the input of a password is requested. Then, whether the password inputted by the operator is correct or not is determined. When the inputted password is correct, the property data is subjected to a symbolic analysis and is stored in the storage apparatus 14. When the inputted password is not correct, then the property data is not subjected to a symbolic analysis and the document image data is subjected to a symbolic analysis.

The interpreter section 21 rasterizes the property data and the document image data temporarily stored in the storage apparatus 14. Specifically, the interpreter section 21 rasterizes the property data and the document image data in order to convert them to data for printing that can be printed by the image forming section 13 (i.e., bitmap data). Based on this data, the exposure apparatus in the image forming section 13 performs a raster scanning on a photoconductor drum to form an electrostatic latent image. The data for printing, which is sent from the storage apparatus 14 to the interpreter section 21, is arranged such that the data for printing of the property data is followed by the document image data. The interpreter section 21 appropriately sends the rasterized data for printing to the I/F 23 for image forming section. It is noted that, with regards to the data for printing, which is sent from the interpreter section 21 to the I/F 23 for image forming section, the data for printing of the property data is sent prior to the document image data. The data for printing, which is sent to the I/F 23 for image forming section is sequentially supplied to the image forming section 13.

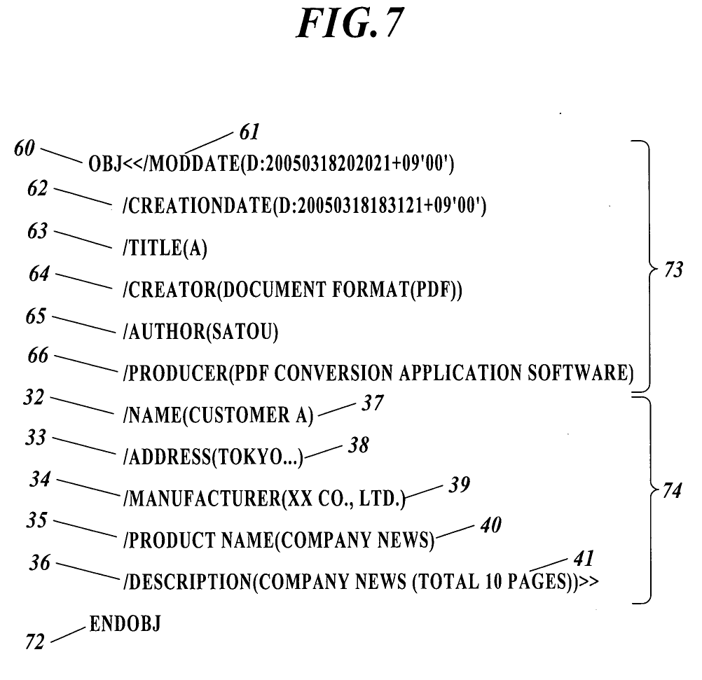

Next, a symbolic analysis processing and a property data extraction processing of a file performed by the job analysis section 20 are described. First, a data set used in a specific data extraction processing is described. FIG. 7 shows an example of a data set showing a key group used in the property data extraction processing. In FIG. 7, the “obj” 60 shows property data; and the “ModDate” 61 shows a date at which the document image data is updated and is recognized by the job analysis section 20 as a start point of a data set of the property data. The “endobj” 72 shows an end point of the property data. The “CreationDate” 62 shows a date and a time at which the document image data is prepared. The “Title” 63 shows a title of the file in which the document data is stored. In this embodiment, the title of the file is “a”0. The “Creator” 64 shows a data format of the application software that has prepared the document image data and shows, when this data format is converted to another data format, the current data format. In FIG. 7, “(document format (PDF))” shows that the document preparation application software of the host 3 has originally prepared the data based on the “document format” and this data is converted by a PDF conversion application software to “PDF” data. The “Author” 65 shows the name of a preparer of the document image data (or the name of an owner of the application software used for preparing the document image data), for example. In this embodiment, the “Author” 65 is “satou”. The “Producer” 66 shows the PDF conversion application software that has subjected the document data prepared by the document preparation software to a PDF conversion and the version thereof, for example.

In FIG. 7, the “name” 32, “address” 33, “manufacturer” 34, “product name” 35, and “description” 36 are keys showing the data of individual items prepared when the host 3 edits the property data (see FIG. 6). The data of the individual items is followed by the data in parenthesis (i.e., “customer A” 37, “Tokyo. . .” 38, “XX Co., Ltd.” 39, “company news” 40, and “company news (total 10 pages)” 41) that shows corresponding information corresponding to the individual items, respectively (see FIG. 6).

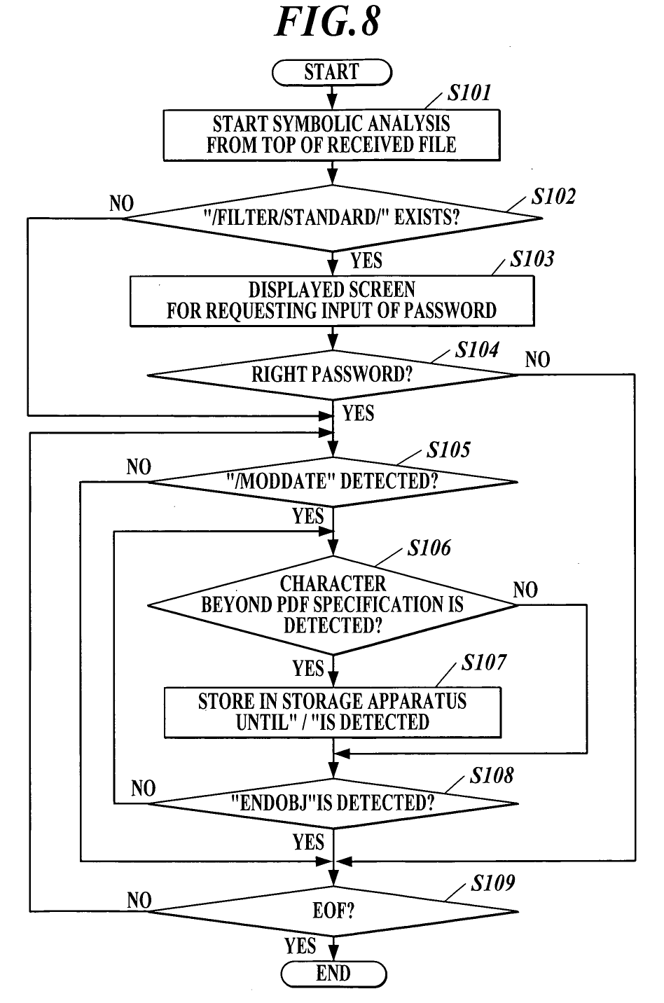

Next, the procedure of the property data extraction processing is described with reference to the flow diagram shown in FIG. 8. It is noted that this flow is realized when the CPU of the image forming apparatus control section 10 executes a control program stored in the storage apparatus 14.

When receiving the document image data sent from the host 3 via the network I/F section 11, the CPU of the image forming apparatus control section 10 allows the job analysis section 20 to perform the symbolic analysis of the received file by starting the analysis from the top of the file (Step S101).

When the analysis of the symbol results in the detection of “/Filter/Standard/” (Step S102: YES) (i.e., when the input of a password is required for the symbolic analysis of the property data included in the document image file), then the display section 16 displays a screen on which the input of a password is requested (Step S103).

When the operator inputs a password through the touch panel provided in the display section 16, whether the password is correct or not is determined (Step S104).

When, in Step S104, the password is determined not correct (Step S104: NO), the property data extraction processing is completed and only the document image data is subjected to the symbolic analysis processing. Thus, only the document pages 76a, 76b, and 76n which are printed based on the document image data are discharged to the discharge tray of the image forming section 13.

When, in Step S104, the password is determined right (Step S104: YES), whether the key of “/ModDate” is detected from the character string subjected to the symbolic analysis or not is determined. When the key of “/ModDate” is detected (Step S105: YES), it is recognized that the file includes the property data and the processing proceeds to Step S106.

In Step S106, whether the property data includes the custom key 74 other than the standard key 73 previously specified by PDF or not is detected. The standard keys previously specified by PDF are, as shown in FIG. 7, the “/ModDate” 61, “/CreationDate” 62, “/Title” 63, “/Creator” 64, “/Author” 65, and “/Producer” 66. When the detection of a key showing an individual item other than the standard key 73 that is uniquely edited by the operator (hereinafter referred to as “custom key” 74) is carried out and not any one of the custom keys 74 is detected (Step S106: NO), the processing proceeds to Step S108 to determine whether the “endobj” 72 is detected or not.

When, in Step S106, any one of the custom keys 74 (Step S106: YES) is detected, the character string is stored in the storage apparatus 14 (Step S107) until the next “/” (slash) is detected. The above process is specifically described with reference to FIG. 7. When the key of “name” 32 at the top of the custom keys 74 is detected, “name (customer A)”, which is the character string until the next “/” (i.e., “/” at the top of “/address” 33) is detected, is stored in the storage apparatus 14.

In Step S107, “name (customer A)” is stored and whether the “endobj” 72 that follows “name (customer A)” and that shows the end of the data set is detected or not in the character string (Step S108) is subsequently determined. In FIG. 7, the character string following the “/name” 32 is not the “endobj” 72 but a key of the “/address” 33 (Step S108: NO). Thus, the processing returns to Step S106 and in Step S107, “address (Tokyo. . .)” is stored in the storage apparatus 14.

When the keys up to the “/description” 36 are sequentially stored in the storage apparatus 14 as described above, then the “endobj” 72 is detected (Step S108: YES). Next, the document image data other than the property data is all subjected to the symbolic analysis and is sequentially stored in the storage apparatus 14 to detect EOF showing the end of the file (Step S109: YES). As a result, the extraction of the specific data and the symbolic analysis processing of the file are completed.

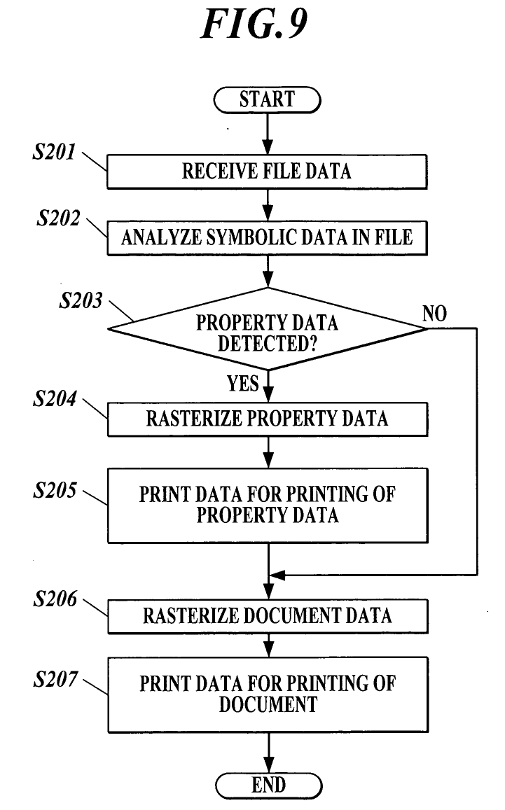

Next, the operation of the image forming apparatus 2 in the image forming system 1 is described with reference to the flow diagram of FIG. 9. This flow is realized when the CPU of the image forming apparatus control section 10 executes a control program stored in the storage apparatus 14. The description below may represent the CPU of the image forming apparatus control section 10 simply as the image forming apparatus control section 10.

The operator of the host 3 uses the document preparation application software or the like to prepare the document image data and converts the prepared document image data by a PDF conversion application software to PDF data. With regards to the PDF document image data generated by the conversion, the property of the document image data is edited by an editing function of “text property” provided in the PDF conversion application software (see FIG. 6). Based on the signal inputted by the operator, the file data of the document for which the property data has been edited is sent from the host-side network I/F section 6 via the network 4 to the image forming apparatus 2.

The current file data from the network 4 is received by the image forming apparatus control section 10 via the network I/F section 11 (Step S201). First, the job analysis section 20 of the image forming apparatus control section 10 receives the data to perform the symbolic analysis of the data by starting the analysis of the data from the top of the file (Step S202).

Next, the image forming apparatus control section 10 uses the job analysis section 20 to perform the above-described symbolic analysis processing and property data extraction processing (see FIG. 8). When this processing extracts the property data (Step S203: YES), the job analysis section 20 sends the property data subjected to the symbolic analysis to the storage apparatus 14 so that the data is stored in the storage apparatus 14. When the property data is not detected or when the password is not correct (Step S203: NO), the processing proceeds to Step S206.

When the EOF is detected and the symbolic analysis of all data that can be subjected to symbolic analysis in the file is completed, the image forming apparatus control section 10 sends the property data after the symbolic analysis temporarily stored in the storage apparatus 14 to the interpreter section 21. Here, the property data is sent prior to the document image data.

Next, the image forming apparatus control section 10 rasterizes the symbolic analysis sent from the interpreter section 21 (Step S204), and the I/F 23 for image formation section sends the data for printing of the property data to the image forming section 13 (Step S205). In accordance with this, the image forming section 13 sends the data for printing to an exposure apparatus (not shown). The exposure apparatus forms an electrostatic latent image showing the data for printing of the property data on the photoconductor drum and then the banner information showing the property of the document is printed on the recording medium. In this way, the banner page 75 is firstly outputted to the discharge tray from the file data of a single document image (see FIG. 10).

Returning to the description of the software processing by the image forming apparatus control section 10, the image forming apparatus control section 10 sends the document image data temporarily stored in the storage apparatus 14 to the interpreter section 21. The interpreter section 21 rasterizes the document image data (Step S206) to generate document image data to be subjected to a printing to send the data for printing of the document image data via the I/F 23 for image forming section to the image forming section 13 (Step S207).

The image forming section 13 forms on the recording medium an image that is shown by the data for printing of the document image data. As shown in FIG. 10, the recording media on which the document image is printed (i.e., document pages 76a, 76b. . . , 76n) are discharged to the discharge tray such that the document pages 76a, 76b. . . , 76n are superimposed so as to be under the banner page 75 when the bundle of the printed media is faced up. As a result, the top of the recording media which is printed by the image forming apparatus 2 based on the document image data sent from the host 3 is the banner page 75 showing the property of the document.

As described above, preferred embodiments of the present invention have been described. However, the present invention is not limited to the various examples as described above. Although the example of this embodiment in particular has a system for converting document data to PDF data, the effect of the present invention can also be provided by another system in which the application software in the host 3 that has prepared the document has not only a function for adding the property data showing the property of the document but also a function for editing the property data. Although the above embodiments used the software processing by the image forming apparatus control section 10 to realize the job analysis section 20, the interpreter section 21, and the I/F 23 for image formation section respectively, these sections may also be partially or entirely realized by hardware.

As described above, according to the image forming system 1 in the example of this embodiment, the job analysis section 20 can extract the property data included in the file data of the document. This eliminates the need for preparing, when a banner page is prepared, the file for the banner page in addition to the file for the document data. Thus, an effect is provided in which the burden for preparing and managing the document data is significantly reduced.

Furthermore, the property data that is extracted by the job analysis section 20 and that is temporarily stored in the storage apparatus 14 is rasterized by the interpreter section 21 prior to the document image data. Then, the rasterized property data is outputted to the image forming section 13 to perform the printing of the banner page 75. As a result, when the printing is performed based on the data stored in the file, the banner page can be firstly printed. Thus, the banner page can be provided at the top of the bundle of the printed papers of the document discharged to the discharge tray of the image forming apparatus 2 when the bundle is faced up. This makes it easy to sort, even when a plurality of bundles of printed papers of the documents based on different pieces of document image data are outputted to the discharge tray, the respective documents, thereby providing an effect of significantly reducing the burden for the operation.

Furthermore, when the job analysis section 20 performs the symbolic analysis of the property data, “/Filter/Standard/” as a character string showing the request for an input of a password is detected and the operator of the image forming apparatus 2 is requested to input a password. When the password inputted by the operator is not correct, the property data is not read from the document image data. This provides an effect for improving the confidentiality of the characteristic information of the document when the image of the document is printed.

The entire disclosure of Japanese Patent Application No. 2005-245815 filed on Aug. 26, 2005, including specifications, claims, drawings and summaries are incorporated herein by reference in their entirety, and the above Japanese Patent Application is the basis for correcting mistranslation of the present U.S. patent application.

What is claimed is:

1. An image data control apparatus comprising:
a job analysis section for detecting property data which is included in a file storing document image data and which shows a property of the document image data; and
an interpreter section for generating data for printing based on the property data detected by the job analysis section and the document image data.

2. The apparatus of claim 1, wherein the property data detected by the job analysis section is sent to the interpreter section prior to the document image data.

3. The apparatus of claim 1, wherein the job analysis section further detects whether an identifier for requesting a predetermined code exists or not when the property data is read from the file, and reads the property data based on a decoding code for decoding the code when the identifier is detected.

4. An image data control method comprising:
detecting property data which is included in a file storing document image data and which shows a property of the document image data; and
generating data for photographic printing based on the property data detected in the detecting of the property data and the document image data.

5. The method of claim 4, further comprising:
sending the property data detected in the generating of the data for printing to the interpreter section prior to the document image data.

6. The method of claim 4, further comprising:
detecting whether an identifier for requesting a predetermined code exists or not when the property data is read from the file in the detecting of the property data, and reading the property data based on a decoding code for decoding the code when the identifier is detected.

7. A recording medium for storing a program, wherein the program causes a computer for controlling document image data to realize:
a job analysis function for detecting property data showing a property of the document image data from a file storing the document image data; and
an interpreter function for generating data for printing based on the property data detected by the job analysis function and the document image data.

8. The recording medium of claim 7, wherein the program causes the computer to further realize a function for sending data for printing of the property data to an interpreter section prior to data for printing of the document image data in the job analysis function.

9. The recording medium of claim 7, wherein the program causes the computer to further realize a function for detecting whether an identifier for requesting a predetermined code exists or not when the property data is read from the file in the job analysis function, and a function for reading the property data based on a decoding code for decoding the code when the identifier is detected.
